(19) United States
(12) Patent Application Publication
(10) Pub. No.: US 2016/0252932 A1
(43) Pub. Date: Sep. 1, 2016

(54) ELECTRONIC DEVICE INCLUDING TOUCH SCREEN AND METHOD OF CONTROLLING SAME

(71) Applicant: Samsung Electronics Co., Ltd., Suwon-si (KR)

(72) Inventors: Suck-HO Seo, Suwon-si (KR); Dong-Hyoun Son, Suwon-si (KR); Sang-Hyeok Sim, Suwon-si (KR); Ji-Ryang Chung, Suwon-si (KR); Chang-Rak Choi, Seoul (KR)

(21) Appl. No.: 14/988,048

(22) Filed: Jan. 5, 2016

(30) Foreign Application Priority Data
Mar. 1, 2015 (KR) 10-2015-0028754
Aug. 12, 2015 (KR) 10-2015-0114008

(51) Int. Cl. G06F 1/16; G06F 3/041; G06F 3/0488; G06F 3/02

(52) U.S. Cl. CPC G06F 1/1628; G06F 3/0227; G06F 3/0412; G06F 3/04886; G06F 1/1677

(57) ABSTRACT

A control method and an apparatus using an accessory device are provided. The control method includes detecting that an accessory device including at least one physical key is mounted to the electronic device, setting a touch screen as an input area in which an input of a physical key is detected according to the physical key and a display area exposed by the physical key, and displaying screen data in the set display area.

### CROSS-REFERENCE TO RELATED APPLICATION(S)

This application claims the benefit under 35 U.S.C. §119(a) of a Korean patent application filed on Mar. 1, 2015 in the Korean Intellectual Property Office and assigned Serial number 10-2015-0028754, and of a Korean patent application filed on Aug. 12, 2015 in the Korean Intellectual Property Office and assigned Serial number 10-2015-0114008, the entire disclosure of each of which is hereby incorporated by reference.

### TECHNICAL FIELD

The present disclosure relates to an electronic device including a touch screen and a method of controlling the same. More particularly, the present disclosure relates to an electronic device and a method of controlling the same, which control an electronic device based on information on an accessory device mounted to the electronic device including a touch screen.

### BACKGROUND

A display unit of a recently released electronic device is formed as a full touch screen. Accordingly, when a user operates the electronic device, the user should control the display unit while checking the display unit all the time. Further, in order to protect an expensive electronic device including a touch screen from an external impact and use various additional functions, users use a cover accessory mounted to cover a part or entirety of the electronic device.

The above information is presented as background information only to assist with an understanding of the present disclosure. No determination has been made, and no assertion is made, as to whether any of the above might be applicable as prior art with regard to the present disclosure.

### SUMMARY

As described above, in order to control the electronic device, it is cumbersome for the user to check the display unit all the time. When the cover accessory is mounted to the electronic device, it is also cumbersome for the user to open the cover accessory, which covers the electronic device, to control the electronic device.

Aspects of the present disclosure are to address at least the above-mentioned problems and/or disadvantages and to provide at least the advantages described below. Accordingly, an aspect of the present disclosure is to provide an electronic device including a touch screen and a method of controlling the same, which perform authentication of a cover accessory having at least one physical key formed therein and control the electronic device through the physical key formed in the cover accessory of which the authentication has been completed.

In accordance with an aspect of the present disclosure, a method of controlling an electronic device including a touch screen is provided. The method includes detecting that an accessory device including at least one physical key is mounted to the electronic device, setting an input area corresponding to the physical key and a remaining display area in the touch screen, and displaying screen data in the set display area.

In accordance with another aspect of the present disclosure, an apparatus is provided. The apparatus includes a sensor unit configured to detect that an accessory device including at least one physical key is mounted to an electronic device including a touch screen, and a controller configured to set an input area corresponding to the physical key and a remaining display area in the touch screen, and to control to display screen data in the set display area.

As described above, the electronic device including the touch screen according to the present disclosure and the method of controlling the same can authenticate the cover accessory having at least one physical key which is mounted to the outside of the electronic device. The electronic device can execute a program related to the cover accessory of which authentication has been completed to perform a function corresponding to a control signal input through the physical key of the cover accessory. Accordingly, it is possible to control the electronic device through the accessory device mounted to the electronic device, thereby improving user convenience.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a network environment including an electronic device according to an embodiment of the present disclosure;

FIG. 2 is a block diagram illustrating a main configuration of an electronic device according to an embodiment of the present disclosure;

FIG. 3 is a block diagram illustrating a program module according to an embodiment of the present disclosure;

FIG. 4 is a block diagram illustrating a main configuration of an electronic device according to an embodiment of the present disclosure;

FIG. 5 is a flowchart illustrating a method of controlling an electronic device by using an accessory device according to an embodiment of the present disclosure;

FIG. 6 is a flowchart illustrating a method of executing a program corresponding to an accessory device according to an embodiment of the present disclosure;

FIGS. 7, 8, 9, 10, and 11 illustrate screen examples for describing an operation of an electronic device to which an accessory device is mounted according to various embodiments of the present disclosure;

FIGS. 12A, 12B, and 12C illustrate screen examples for describing a structure of a physical key formed in an accessory device according to various embodiments of the present disclosure;

FIGS. 13, 14, and 15 illustrate screen examples for describing a cover type accessory device according to various embodiment of the present disclosure; and

FIGS. 16 and 17 illustrate screen examples for describing a mounted type accessory device according to various embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including both at least one A and at least one B.

The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude various embodiments of the present disclosure.

An electronic device according to various embodiments of the present disclosure may include at least one of, for example, a smart phone, a tablet personal computer (PC), a mobile phone, a video phone, an electronic book reader (e-book reader), a desktop PC, a laptop PC, a netbook computer, a workstation, a server, a personal digital assistant (PDA), a portable multimedia player (PMP), a Moving Picture Experts Group phase 1 or phase 2 (MPEG-1 or MPEG-2) audio layer-3 (MP3) player, a mobile medical device, a camera, and a wearable device. According to various embodiments of the present disclosure, the wearable device may include at least one of an accessory type (e.g., a watch, a ring, a bracelet, an anklet, a necklace, a glasses, a contact lens, or a head-mounted device (HMD)), a fabric or clothing integrated type (e.g., an electronic clothing), a body-mounted type (e.g., a skin pad, or tattoo), and a bio-implantable type (e.g., an implantable circuit).

According to various embodiments of the present disclosure, the electronic device may be a home appliance. The home appliance may include at least one of, for example, a television (TV), a digital versatile disc (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to an embodiment of the present disclosure, the electronic device may include at least one of various medical devices (e.g., various portable medical measuring devices (a blood glucose monitoring device, a heart rate monitoring device, a blood pressure measuring device, a body temperature measuring device, etc.), a magnetic resonance angiography (MRA), a magnetic resonance imaging (MRI), a computed tomography (CT) machine, and an ultrasonic machine), a navigation device, a global positioning system (GPS) receiver, an event data recorder (EDR), a flight data recorder (FDR), a vehicle infotainment devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to various embodiments of the present disclosure, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to various embodiments of the present disclosure may be a flexible device. Further, the electronic device according to an embodiment of the present disclosure is not limited to the aforementioned devices, and may include a new electronic device according to the development of technology

Hereinafter, an electronic device according to various embodiments of the present disclosure will be described with reference to the accompanying drawings. As used herein, the term “user” may indicate a person who uses an electronic device or a device (e.g., an artificial intelligence electronic device) that uses an electronic device.

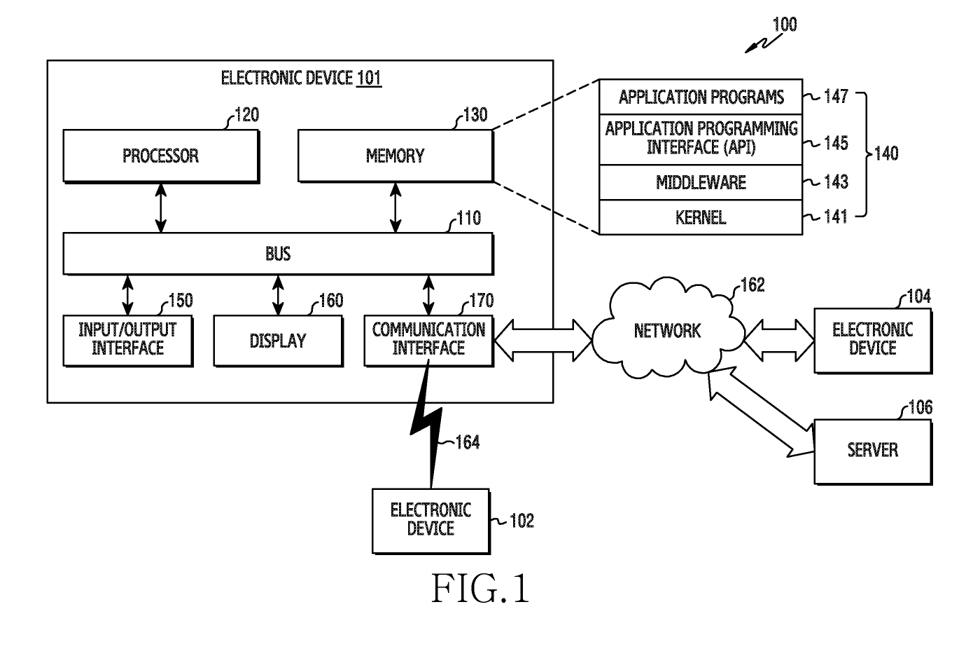

FIG. 1 illustrates a network environment including an electronic device according to an embodiment of the present disclosure.

Referring to FIG. 1, an electronic device 101 within a network environment 100, according to various embodiments of the present disclosure, will be described. The electronic device 101 may include a bus 110, a processor 120, a memory 130, an input/output interface 150, a display 160, and a communication interface 170. In various embodiments of the present disclosure, the electronic device 101 may omit at least one of the above elements or may further include other elements.

The bus 110 may include, for example, a circuit for connecting the elements 110-170 and transferring communication (e.g., control messages and/or data) between the elements.

The processor 120 may include one or more of a CPU, an AP, and a communication processor (CP). The processor 120, for example, may carry out operations or data processing relating to control and/or communication of at least one other element of the electronic device 101.

The memory 130 may include a volatile memory and/or a non-volatile memory. The memory 130 may store, for example, instructions or data relevant to at least one other element of the electronic device 101. According to an embodiment of the present disclosure, the memory 130 may store software and/or a program 140. The software and/or the program 140 may include, for example, a kernel 141, middleware 143, an application programming interface (API) 145, and/or application programs (or “applications”) 147. At least some of the kernel 141, the middleware 143, and the API 145 may be referred to as an operating system (OS).

The kernel 141 may control or manage system resources (e.g., the bus 110, the processor 120, or the memory 130) used for performing an operation or function implemented by the other programs (e.g., the middleware 143, the API 145, or the application programs 147). Furthermore, the kernel 141 may provide an interface through which the middleware 143, the API 145, or the application programs 147 may access the individual elements of the electronic device 101 to control or manage the system resources.

The middleware 143, for example, may function as an intermediary for allowing the API 145 or the application programs 147 to communicate with the kernel 141 to exchange data.

In addition, the middleware 143 may process one or more task requests received from the application programs 147 according to priorities thereof. For example, the middleware 143 may assign priorities for using the system resources (e.g., the bus 110, the processor 120, the memory 130, or the like) of the electronic device 101, to at least one of the application programs 147. For example, the middleware 143 may perform scheduling or loading balancing on the one or more task requests by processing the one or more task requests according to the priorities assigned thereto.

The API 145 is an interface through which the applications 147 control functions provided from the kernel 141 or the middleware 143, and may include, for example, at least one interface or function (e.g., instruction) for file control, window control, image processing, or text control.

The input/output interface 150, for example, may function as an interface that may transfer instructions or data input from a user or another external device to the other element(s) of the electronic device 101. Furthermore, the input/output interface 150 may output the instructions or data received from the other element(s) of the electronic device 101 to the user or another external device.

The display 160 may include, for example, a liquid crystal display (LCD), a light emitting diode (LED) display, an organic LED (OLED) display, a micro electro mechanical system (MEMS) display, or an electronic paper display. The display 160, for example, may display various types of content (e.g., text, images, videos, icons, or symbols) for the user. The display 160 may include a touch screen and receive, for example, a touch, gesture, proximity, or hovering input using an electronic pen or the user's body part.

The communication interface 170, for example, may set communication between the electronic device 101 and an external device (e.g., the first external electronic device 102, the second external electronic device 104, or a server 106). For example, the communication interface 170 may be connected to a network 162 through wireless or wired communication to communicate with the external device (e.g., the second external electronic device 104 or the server 106).

The wireless communication may use at least one of, for example, long term evolution (LTE), LTE-advanced (LTE-A), code division multiple access (CDMA), wideband CDMA (WCDMA), universal mobile telecommunications system (UMTS), wireless broadband (WiBro), and global system for mobile communications (GSM), as a cellular communication protocol. In addition, the wireless communication may include, for example, short range communication 164. The short-range communication 164 may be performed by using at least one of, for example, Wi-Fi, Bluetooth (BT), near field communication (NFC), and global navigation satellite system (GNSS). The GNSS may include at least one of, for example, a GPS, a GLONASS, a BeiDou navigation satellite system (hereinafter referred to as “BeiDou”), and a European global satellite-based navigation system (Galileo), according to a use area, a bandwidth, or the like. Hereinafter, in the present disclosure, the “GPS” may be interchangeably used with the “GNSS”. The wired communication may include at least one of, for example, a universal serial bus (USB), a high definition multimedia interface (HDMI), recommended standard 232 (RS-232), and a plain old telephone service (POTS). The network 162 may include at least one of a communication network such as a computer network (e.g., a local area network (LAN) or a wide area network (WAN)), the Internet, and a telephone network.

Each of the first and second external electronic devices 102 and 104 may be of a type identical to or different from that of the electronic device 101. According to an embodiment of the present disclosure, the server 106 may include a group of one or more servers. According to various embodiments of the present disclosure, all or some of the operations performed in the electronic device 101 may be performed in another electronic device or a plurality of electronic devices (e.g., the electronic devices 102 and 104 or the server 106). According to an embodiment of the present disclosure, when the electronic device 101 has to perform some functions or services automatically or in response to a request, the electronic device 101 may make a request for performing at least some functions relating thereto to another device (e.g., the electronic device 102 or 104 or the server 106) instead of performing the functions or services by itself or in addition. Another electronic device may execute the requested functions or the additional functions, and may deliver a result of the execution to the electronic device 101. The electronic device 101 may process the received result as it is or additionally to provide the requested functions or services. To achieve this, for example, cloud computing, distributed computing, or client-server computing technology may be used.

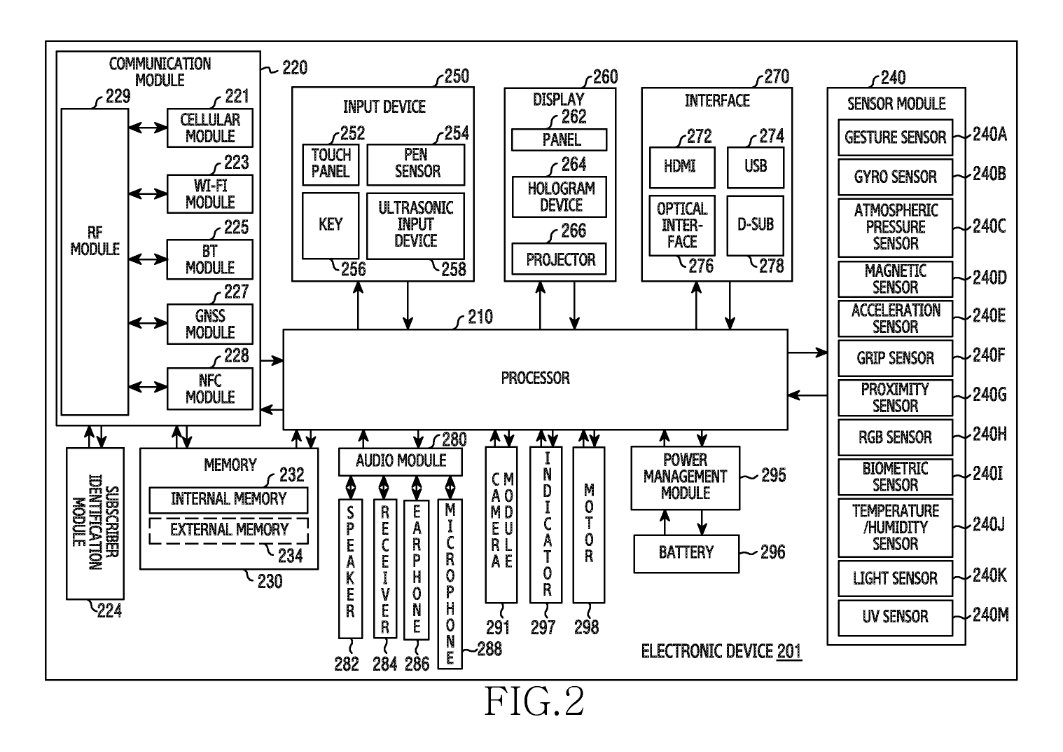

FIG. 2 is a block diagram of an electronic device 201 according to various embodiments of the present disclosure.

For example, referring to FIG. 2, the electronic device 201 may include the whole or part of the electronic device 101 illustrated in FIG. 1. The electronic device 201 may include at least one processor (e.g., AP) 210, a communication module 220, a subscriber identification module (SIM) 224, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software components connected to the processor 210 by driving an operating system or an application program and perform processing of various pieces of data and calculations. The processor 210 may be implemented by, for example, a system on chip (SoC). According to an embodiment of the present disclosure, the processor 210 may further include a GPU and/or an image signal processor. The processor 210 may include at least some (e.g., a cellular module 221) of the elements illustrated in FIG. 2. The processor 210 may load, into a volatile memory, instructions or data received from at least one (e.g., a non-volatile memory) of the other elements and may process the loaded instructions or data, and may store various data in a non-volatile memory.

The communication module 220 may have a configuration equal or similar to that of the communication interface 170 of FIG. 1. The communication module 220 may include, for example, the cellular module 221, a Wi-Fi module 223, a BT module 225, a GNSS module 227 (e.g., a GPS module, a GLONASS module, a BeiDou module, or a Galileo module), an NFC module 228, and a radio frequency (RF) module 229.

The cellular module 221 may provide a voice call, image call, a text message service, or an Internet service through, for example, a communication network. According to an embodiment of the present disclosure, the cellular module 221 may distinguish between and authenticate electronic devices 201 within a communication network using a subscriber identification module (for example, the SIM card 224). According to an embodiment of the present disclosure, the cellular module 221 may perform at least some of the functions that the processor 210 may provide. According to an embodiment of the present disclosure, the cellular module 221 may include a CP.

Each of the Wi-Fi module 223, the BT module 225, the GNSS module 227, and the NFC module 228 may include, for example, a processor for processing data transmitted and received through the relevant module. According to various embodiments of the present disclosure, at least some (e.g., two or more) of the cellular module 221, the Wi-Fi module 223, the BT module 225, the GNSS module 227, and the NFC module 228 may be included in one integrated chip (IC) or IC package.

The RF module 229 may transmit/receive, for example, a communication signal (for example, an RF signal). The RF module 229 may include, for example, a transceiver, a power amplifier module (PAM), a frequency filter, a low noise amplifier (LNA), and an antenna. According to an embodiment of the present disclosure, at least one of the cellular module 221, the Wi-Fi module 223, the BT module 225, the GNSS module 227, and the NFC module 228 may transmit and receive RF signals through a separate RF module.

The SIM 224 may include, for example, a card including a subscriber identity module and/or an embedded SIM, and may contain unique identification information (e.g., an integrated circuit card identifier (ICCID)) or subscriber information (e.g., an international mobile subscriber identity (IMSI)).

The memory 230 (for example, the memory 130) may include, for example, an internal memory 232 or an external memory 234. The internal memory 232 may include at least one of a volatile memory (for example, a dynamic random access memory (DRAM), a static RAM (SRAM), a synchronous DRAM (SDRAM), and the like) and a non-volatile memory (for example, a one time programmable read only memory (OTPROM), a PROM, an erasable and PROM (EPROM), an electrically erasable and programmable ROM (EEPROM), a mask ROM, a flash ROM, a flash memory (for example, a NAND flash memory or a NOR flash memory), a hard disk drive, a solid state drive (SSD), and the like).

The external memory 234 may further include a flash drive, for example, a compact flash (CF), a secure digital (SD), a micro-SD, a mini-SD, an extreme digital (xD), a memory stick, or the like. The external memory 234 may be functionally and/or physically connected to the electronic device 201 through various interfaces.

The sensor module 240 may measure a physical quantity or detect an operation state of the electronic device 201, and may convert the measured or detected information into an electrical signal. For example, the sensor module 240 may include at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (for example, a red/green/blue (RGB) sensor), a biometric 2401, a temperature/humidity sensor 240J, a light sensor 240K, and an ultra violet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling one or more sensors included therein. In various embodiments of the present disclosure, the electronic device 201 may further include a processor configured to control the sensor module 240 as a part of or separately from the processor 210, and may control the sensor module 240 while the processor 210 is in a sleep state.

The input device 250 may include, for example, a touch panel 252, a (digital) pen sensor 254, a key 256, or an ultrasonic input device 258. The touch panel 252 may use at least one of, for example, a capacitive type, a resistive type, an infrared type, and an ultrasonic type. Also, the touch panel 252 may further include a control circuit. The touch panel 252 may further include a tactile layer and provide a tactile reaction to the user.

The (digital) pen sensor 254 may include, for example, a recognition sheet which is a part of the touch panel or is separated from the touch panel. The key 256 may include, for example, a physical button, an optical key or a keypad. The ultrasonic input device 258 may detect ultrasonic wavers generated by an input tool through a microphone (for example, a microphone 288) and identify data corresponding to the detected ultrasonic waves.

The display 260 (for example, the display 160) may include a panel 262, a hologram device 264 or a projector 266. The panel 262 may include a configuration that is identical or similar to the display 160 illustrated in FIG. 1. The panel 262 may be implemented to be, for example, flexible, transparent, or wearable. The panel 262 and the touch panel 252 may be implemented as one module. The hologram device 264 may show a three dimensional image in the air by using an interference of light. The projector 266 may display an image by projecting light onto a screen. The screen may be located, for example, inside or outside the electronic device 201. According to an embodiment of the present disclosure, the display 260 may further include a control circuit for controlling the panel 262, the hologram device 264, or the projector 266.

The interface 270 may include, for example, an HDMI 272, a USB 274, an optical interface 276, or a D-subminiature (D-sub) 278. The interface 270 may be included in, for example, the communication interface 170 illustrated in FIG. 1. Additionally or alternatively, the interface 270 may include, for example, a mobile high-definition link (MHL) interface, an SD card/multi-media card (MMC) interface, or an infrared data association (IrDA) standard interface.

The audio module 280 may bilaterally convert, for example, a sound and an electrical signal. At least some elements of the audio module 280 may be included in, for example, the input/output interface 150 illustrated in FIG. 1. The audio module 280 may process sound information which is input or output through, for example, a speaker 282, a receiver 284, earphones 286, the microphone 288 or the like.

The camera module 291 is a device which may photograph a still image and a dynamic image. According to an embodiment of the present disclosure, the camera module 291 may include one or more image sensors (for example, a front sensor or a back sensor), a lens, an image signal processor (ISP) or a flash (for example, LED or xenon lamp).

The power management module 295 may manage, for example, power of the electronic device 201. According to an embodiment of the present disclosure, the power management module 295 may include a power management IC (PMIC), a charger IC, or a battery or fuel gauge. The PMIC may use a wired and/or wireless charging method. Examples of the wireless charging method may include, for example, a magnetic resonance method, a magnetic induction method, an electromagnetic method, and the like. Additional circuits (e.g., a coil loop, a resonance circuit, a rectifier, etc.) for wireless charging may be further included. The battery gauge may measure, for example, a residual quantity of the battery 296, and a voltage, a current, or a temperature during the charging. The battery 296 may include, for example, a rechargeable battery or a solar battery.

The indicator 297 may display a particular state (e.g., a booting state, a message state, a charging state, or the like) of the electronic device 201 or a part (e.g., the processor 210). The motor 298 may convert an electrical signal into mechanical vibration, and may generate vibration, a haptic effect, or the like. Although not illustrated, the electronic device 201 may include a processing unit (e.g., a GPU) for supporting a mobile TV. The processing unit for supporting mobile TV may, for example, process media data according to a certain standard such as digital multimedia broadcasting (DMB), digital video broadcasting (DVB), or mediaFLO™.

Each of the above-described component elements of hardware according to the present disclosure may be configured with one or more components, and the names of the corresponding component elements may vary based on the type of electronic device. The electronic device according to various embodiments of the present disclosure may include at least one of the aforementioned elements. Some elements may be omitted or other additional elements may be further included in the electronic device. Also, some of the hardware components according to various embodiments of the present disclosure may be combined into one entity, which may perform functions identical to those of the relevant components before the combination.

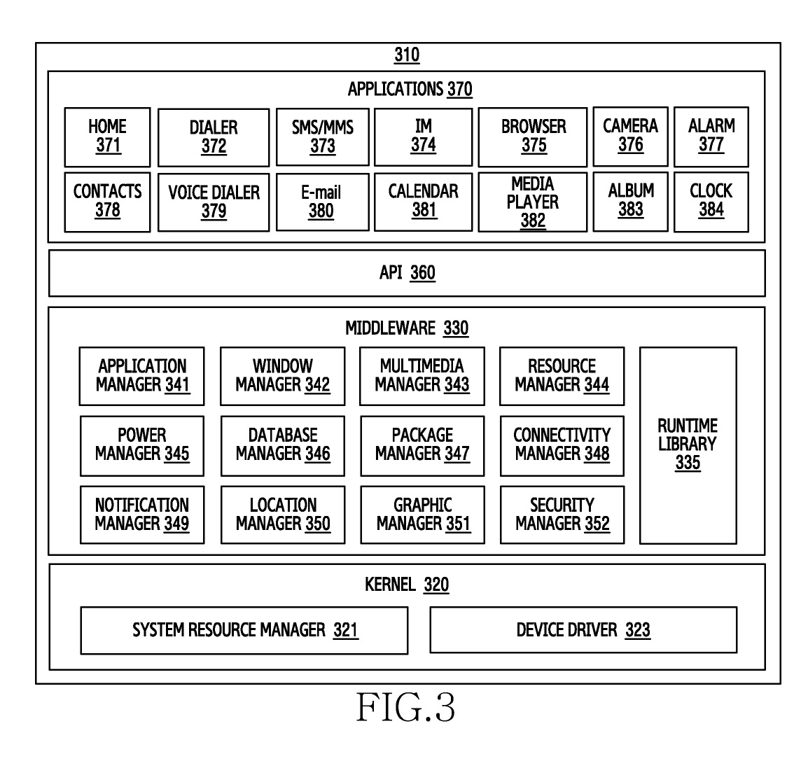

FIG. 3 is a block diagram of a program module according to various embodiments of the present disclosure.

Referring to FIG. 3 according to an embodiment of the present disclosure, the program module 310 (for example, the software and/or the program 140) may include an OS for controlling resources related to the electronic device (for example, the electronic device 101) and/or various applications (for example, the application programs 147) executed in the OS. The OS may be, for example, Android, iOS, Windows, Symbian, Tizen, Bada, or the like.

The program module 310 may include a kernel 320, middleware 330, an API 360, and/or an application 370. At least some of the program module 310 may be preloaded on the electronic device, or may be downloaded from an external electronic device (e.g., the electronic device 102 or 104, or the server 106).

The kernel 320 (e.g., the kernel 141) may include, for example, a system resource manager 321 and/or a device driver 323. The system resource manager 321 may perform the control, allocation, retrieval, or the like of system resources. According to an embodiment of the present disclosure, the system resource manager 321 may include a process manager, a memory manager, a file system manager, or the like. The device driver 323 may include, for example, a display driver, a camera driver, a BT driver, a shared memory driver, a USB driver, a keypad driver, a Wi-Fi driver, an audio driver, or an inter-process communication (IPC) driver.

The middleware 330 may provide a function used by the applications 370 in common or provide various functions to the applications 370 through the API 360 so that the applications 370 can efficiently use limited system resources within the electronic device. According to an embodiment of the present disclosure, the middleware 330 (for example, the middleware 143) may include, for example, at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses in order to add a new function through a programming language while the applications 370 are being executed. The runtime library 335 may perform input/output management, memory management, the functionality for an arithmetic function, or the like.

The application manager 341 may manage, for example, the life cycle of at least one of the applications 370. The window manager 342 may manage graphical user interface (GUI) resources used for the screen. The multimedia manager 343 may determine a format used to reproduce various media files, and may encode or decode a media file by using a coder/decoder (codec) appropriate for the relevant format. The resource manager 344 may manage resources, such as a source code, a memory, a storage space, and the like of at least one of the applications 370.

The power manager 345 may operate together with a basic input/output system (BIOS) to manage a battery or power and may provide power information used for the operation of the electronic device. The database manager 346 may generate, search for, and/or change a database to be used by at least one of the applications 370. The package manager 347 may manage the installation or update of an application distributed in the form of a package file.

The connectivity manager 348 may manage a wireless connection such as, for example, Wi-Fi or BT. The notification manager 349 may display or notify of an event, such as an arrival message, an appointment, a proximity notification, and the like, in such a manner as not to disturb the user. The location manager 350 may manage location information of the electronic device. The graphic manager 351 may manage a graphic effect, which is to be provided to the user, or a UI related to the graphic effect. The security manager 352 may provide various security functions used for system security, user authentication, and the like. According to an embodiment of the present disclosure, when the electronic device (e.g., the electronic device 101) has a telephone call function, the middleware 330 may further include a telephony manager for managing a voice call function or a video call function of the electronic device.

The middleware 330 may include a middleware module that forms a combination of various functions of the above-described elements. The middleware 330 may provide a module specialized for each type of OS in order to provide a differentiated function. Also, the middleware 330 may dynamically delete some of the existing elements, or may add new elements.

The API 360 (e.g., the API 145) is, for example, a set of API programming functions, and may be provided with a different configuration according to an OS. For example, in the case of Android or iOS, one API set may be provided for each platform. In the case of Tizen, two or more API sets may be provided for each platform.

The applications 370 (for example, the application program 147) may include, for example, one or more applications which can provide functions such as home 371, dialer 372, short message service (SMS)/multimedia message service (MMS) 373, instant message (IM) 374, browser 375, camera 376, alarm 377, contacts 378, voice dialer 379, email 380, calendar 381, media player 382, album 383, clock 384, health care (for example, measure exercise quantity or blood sugar), or environment information (for example, atmospheric pressure, humidity, or temperature information).

According to an embodiment of the present disclosure, the applications 370 may include an application (hereinafter, referred to as an “information exchange application” for convenience of description) supporting information exchange between the electronic device (e.g., the electronic device 101) and an external electronic device (e.g., the electronic device 102 or 104). The application associated with information exchange may include, for example, a notification relay application for forwarding specific information to an external electronic device, or a device management application for managing an external electronic device.

For example, the notification relay application may include a function of delivering, to the external electronic device (e.g., the electronic device 102 or 104), notification information generated by other applications (e.g., an SMS/MMS application, an email application, a health care application, an environmental information application, etc.) of the electronic device 101. Further, the notification relay application may receive notification information from, for example, an external electronic device and provide the received notification information to a user.

The device management application may manage (for example, install, delete, or update), for example, a function for at least a part of the external electronic device (for example, the electronic device 102 or 104) communicating with the electronic device (for example, turning on/off the external electronic device itself (or some elements thereof) or adjusting brightness (or resolution) of a display), applications executed in the external electronic device, or services provided from the external electronic device (for example, a telephone call service or a message service).

According to an embodiment of the present disclosure, the applications 370 may include applications (for example, a health care application of a mobile medical appliance or the like) designated according to attributes of the external electronic device 102 or 104. According to an embodiment of the present disclosure, the application 370 may include an application received from the external electronic device (e.g., the server 106, or the electronic device 102 or 104). According to an embodiment of the present disclosure, the application 370 may include a preloaded application or a third party application which can be downloaded from the server. Names of the elements of the program module 310, according to the above-described embodiments of the present disclosure, may change depending on the type of OS.

According to various embodiments of the present disclosure, at least some of the program module 310 may be implemented in software, firmware, hardware, or a combination of two or more thereof. At least some of the program module 310 may be implemented (e.g., executed) by, for example, the processor (e.g., the processor 210). At least some of the program module 310 may include, for example, a module, a program, a routine, a set of instructions, and/or a process for performing one or more functions.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an application-specific IC (ASIC) chip, a field-programmable gate arrays (FPGA), and a programmable-logic device for performing operations which has been known or are to be developed hereinafter.

According to various embodiments of the present disclosure, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable storage medium may be, for example, the memory 130.

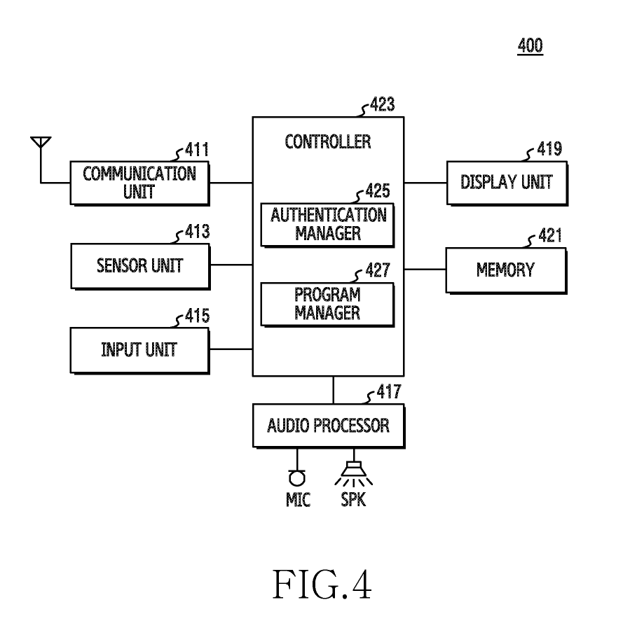

FIG. 4 is a block diagram illustrating a main configuration of an electronic device 400 according to an embodiment of the present disclosure.

Referring to FIG. 4, the electronic device 400 according to an embodiment of the present disclosure may include a communication unit 411, a sensor unit 413, an input unit 415, an audio processor 417, a display unit 419, a memory 421, and a controller 423.

The communication unit 411 may perform communication in the electronic device 400. At this time, the communication unit 411 may communicate with an external device (not shown) including an accessory device (not shown) through various communication schemes. The communication unit 411 may perform at least one of wireless communication and wired communication. To this end, the communication unit 411 may access at least one of a mobile communication network and a data communication network. The communication unit 411 may perform short-range communication with the accessory device. At this time, the communication scheme may include wireless communication such as BT, NFC, and RF identification (RFID). Further, the communication unit 411 may include a port at the rear surface of the electronic device 400 to communicate with the accessory device through a wire.

The sensor unit 413 may detect an opening and closing state of the accessory device mounted to the electronic device 400 with respect to the display unit 419. To this end, the sensor unit 413 may identify opening/closing of the accessory device through detection by a hall sensor included in the accessory device. The sensor unit 413 may include an illumination sensor to identify the opening/closing of the accessory device. An opening operation of the accessory device may correspond to a state for identifying the display unit 419 and a closing operation of the accessory device may correspond to a state where the accessory device covers the display unit 419.

The sensor unit 413 may detect whether the accessory device is mounted to/removed from the display unit 419. The accessory device may be mounted to a part of the display unit 419. The sensor unit 413 may detect whether the accessory device is mounted/removed through the detection by the hall sensor included in the accessory device. The sensor unit 413 may provide the controller 423 with the identified information on whether the accessory device is open/closed or mounted/removed.

The input unit 415 may generate input data in the electronic device 400. At this time, the input unit 415 may generate input data in response to a user input of the electronic device 400. The input unit 415 may include at least one input means. The input unit 415 may include a key pad, a dome switch, a physical button, a touch panel, and a jog & shuttle.

The audio processor 417 may process an audio signal. At this time, the audio processor 417 may include a speaker (SPK) and a microphone (MIC). The audio processor 417 may reproduce the audio signal output from the controller 423 through the speaker. The audio processor 417 may transfer the audio signal generated from the microphone to the controller 423.

The display unit 419 may set an entire area of the display unit 419 as a display area and an input area under a control of the controller 423. The display unit 419 may display an execution screen of a program corresponding to the accessory device in the display area under the control of the controller 423. The display unit 419 may display an execution screen of an executed function (for example, an application) in the display area under the control of the controller 423. The display area may be an area corresponding to a display window formed in the accessory device. Further, the display area may be a partial area of the display unit 419 exposed by the accessory device mounted to the part of the display unit 419. The display unit 419 may include an LCD, an LED display, an OLED display, an MEMS display, and an electronic paper display. The display unit 419 may include a plurality of light emitting diodes.

Further, the display unit 419 may be combined with the input unit 415 to be implemented as a touch screen. When the display unit 419 is implemented as the touch screen, the display unit (hereinafter, referred to as the touch screen 419) may draw, in the input area, at least one virtual key corresponding to at least one physical key arranged at the accessory device. The input area may be an area corresponding to at least one physical key formed in the accessory device and may be an area corresponding to the accessory device mounted to the part of the touch screen 419. The touch screen 419 may not draw the virtual key in the input area.

The memory 421 may store operation programs of the electronic device 400. The memory 421 may store a program corresponding to the accessory device. The program may be, for example, an application.

When it is identified that the accessory device including at least one physical key is mounted to the touch screen 419, the controller 423 may perform authentication of the accessory device and execute a program corresponding to the accessory device. The controller 423 may set an input area in which an input of the physical key is detected in accordance with the physical key based on the program and a display area exposed by the physical key. The controller 423 may display screen data in the display area. When an input by the physical key is generated while the accessory device is closed, the controller 423 may detect a control signal according to the input in the input area. The controller 423 may perform a function corresponding to the detected control signal. To this end, the controller 423 may include an authentication manager 425 and a program manager 427.

When the sensor unit 413 detects that the accessory device covers an entirety or a part of the touch screen 419 of the electronic device 400, the authentication manager 425 may receive information on the accessory device from the accessory device. At this time, the information on the accessory device may include at least one of a manufacturer of the accessory device, whether the accessory device is a genuine product, a product name, a color, a type of the accessory device, an ID format, a type and arrangement information on at least one physical key included in the accessory device, information on a display window formed in the accessory device, and an access address of a webpage of a manufacturer, and may be formed as shown in table 1 below.

According to an embodiment of the present disclosure, the accessory device may be a cover accessory device including a display window and at least one physical key and may cover an entire upper part of the electronic device 400. The accessory device may be a cover accessory device which includes at least one physical key and covers only some of the upper part of the electronic device 400. The display window of the accessory device may be formed with a transparent material.

According to an embodiment of the present disclosure, the accessory device may be a pair of cases mounted to a rear surface and a front surface of the electronic device 400, that is, a part of the touch screen 419. At this time, the case mounted to the rear surface of the electronic device 400 may include a chip for NFC communication with the electronic device 400. The case mounted to the part of the touch screen 419 of the electronic device 400 may include a hall sensor and have at least one physical key. Further, the accessory device may be mounted to only the part of the touch screen 419 of the electronic device 400 without the case mounted to the rear surface of the electronic device 400. In this case, the accessory device may include the hall sensor and the chip for NFC communication with the electronic device 400 and have at least one physical key.

At this time, at least one physical key included in the accessory device may be a keypad with a qwerty keyboard. The physical key may be formed as a keypad with the qwerty keyboard, a 3×4 array keypad, a keypad including the qwerty keyboard and a function key, a keypad including a game control key for controlling a game, and a touch pad which can be touched using an external device.

TABLE 1

| | Number of | Detailed | |
|---|---|---|---|
| Item | allocated bits | information | Example |
| Product name | 8 bit (256 types) | Task model | 00(hex) |
| Genuine product or | 8 bit (256 types) | Genuine | 00(hex) |
| not | | product/SMAPP | |
| Color | 8 bit (256 types) | Black/white | 00(hex) |
| Type | 8 bit (256 types) | Flip cover/S-view | 00(hex) |
| | | cover | |
| ID format | 8 bit (256 types) | ID format ver | 00(hex) |
| Manufacturer | 16 bit (65K) | Manufacturer name | 0000(hex) |
| information | | | |
| Manufacturer | 8 bit (256 types) | Uniform resource | 00(hex) |
| webpage | | identifier (URI) | |
| | | address | |
| Physical key type | 8 bit | Keyboard type | 00(hex) |

The authentication manager 425 may authenticate the accessory device by using information on whether the accessory device is a genuine product which is included in the information on the accessory device. When the authentication of the accessory device is completed, the authentication manager 425 may identify whether a program corresponding to the accessory device is stored in the memory 421 and provide a result of the identification to the program manager 427.

When the program corresponding to the accessory device is stored in the memory 421, the program manager 427 may execute the program. When the program corresponding to the accessory device is not stored in the memory 421, the program manager 427 may access a server (not shown) existing outside the electronic device 400, download a program related to the accessory device, and install the downloaded program. The program manager 427 may execute the installed program. At this time, the server may be at least one of a content providing server, a store server, a market server, and a manufacturer webpage.

The program manager 427 may set a display area and an input area in the touch screen 419. The program manager 427 may set the display area based on information on the display window of the accessory device by the program corresponding to the accessory device of which authentication has been completed. The program manager 427 may set the input area based on information on the physical key of the accessory device by the program. When the accessory device is an accessory device mounted to the part of the touch screen 419, the program manager 427 may set an area of the touch screen 419 corresponding to the area in which the accessory device is mounted as the input area. The program manager 427 may set an area other than the input area as the display area.

The program manager 427 may display screen data according to execution of the program on the touch screen 419. The program manager 427 may display screen data according to execution of the program in the set display area. When the accessory device covers the touch screen 419 or is mounted to the touch screen 419 in a state where a standby screen is displayed on the touch screen 419, the program manager 427 may resize the standby screen to fit the display area. The program manager 427 may display the resized screen data in the display area. The program manager 427 may rearrange one or more icons, which had been in the standby screen displayed on the touch screen 419 before the resizing, and display the rearranged icons in the display area.

When execution of a particular application is detected in a state where the accessory device covers the touch screen 419 or is mounted to the touch screen 419, the program manager 427 may display an execution screen of the particular application in the display area. The program manager 427 may control the execution screen to fit the display area and display the execution screen in the display area.

The program manager 427 may identify the type and arrangement information on at least one physical key included in the accessory device in the information on the accessory device through the program. The program manager 427 may set an area corresponding to the physical key in the touch screen 419 as the input area. The program manager 427 may draw at least one virtual key corresponding to the type and arrangement information on at least one physical key in the set input area. The program manager 427 may allocate a key value, which is equal to that allocated to the physical key, to the virtual key.

When an input is generated through the physical key, the program manager 427 may identify a control signal corresponding to the generated input. The program manager 427 may perform a function corresponding to the identified control signal and display screen data according to performance of the function in the display area of the touch screen 419 corresponding to the display window of the accessory device. When the input is generated in the physical key, for example, when the user presses the physical key, a change in capacitance of the touch screen 419 may be generated. The program manager 427 may identify a coordinate value of a location where the capacitance is generated. The program manager 427 may identify a virtual key corresponding to the identified coordinate value and a key value allocated to the virtual key, and perform a function corresponding to the key value. The program manager 427 may display screen data corresponding to the performed function in the display area.

When the accessory device, which covers the touch screen 419, opens or is removed from the touch screen 419, the program manager 427 may combine the display area and the input area into the entire area. The program manager 427 may change the size of the screen data, which is being displayed in the display area, to correspond to the entire area of the touch screen 419 and display the screen data on the touch screen 419. The program manager 427 may rearrange and display at least one icon arranged in the screen data which is displayed in the display area.

According to an embodiment of the present disclosure, the electronic device 400 including the touch screen (for example, the display unit 419) may include the sensor unit 413 for detecting mounting of the accessory device including at least one physical key, and the controller 423 for setting the input area corresponding to the physical key and the display area corresponding to the remaining area in the touch screen 419 and displaying screen data in the display area. The controller 423 may control screen data according to an input detected in the input area and displays the controlled screen data. The screen data may include at least one item. The controller 423 may arrange at least one item in the display area.

The controller 423 may display screen data in the entire area of the touch screen 419 if the accessory device is removed from the electronic device 400.

The controller 423 may authenticate the accessory device, execute a program corresponding to the accessory device, and set the display area and the input area based on the program.

The controller 423 may execute the program if the program is installed. The controller 423 may access a server to install the program if the program is not installed, and may install the program. The program may include information on the type and arrangement information on at least one physical key. The controller 423 may draw at least one virtual key corresponding to the information on the type and arrangement information on at least one physical key in the input area.

The controller 423 may identify a virtual key in response to an input detected on at least one physical key, and control and display screen data according to a key value corresponding to the virtual key.

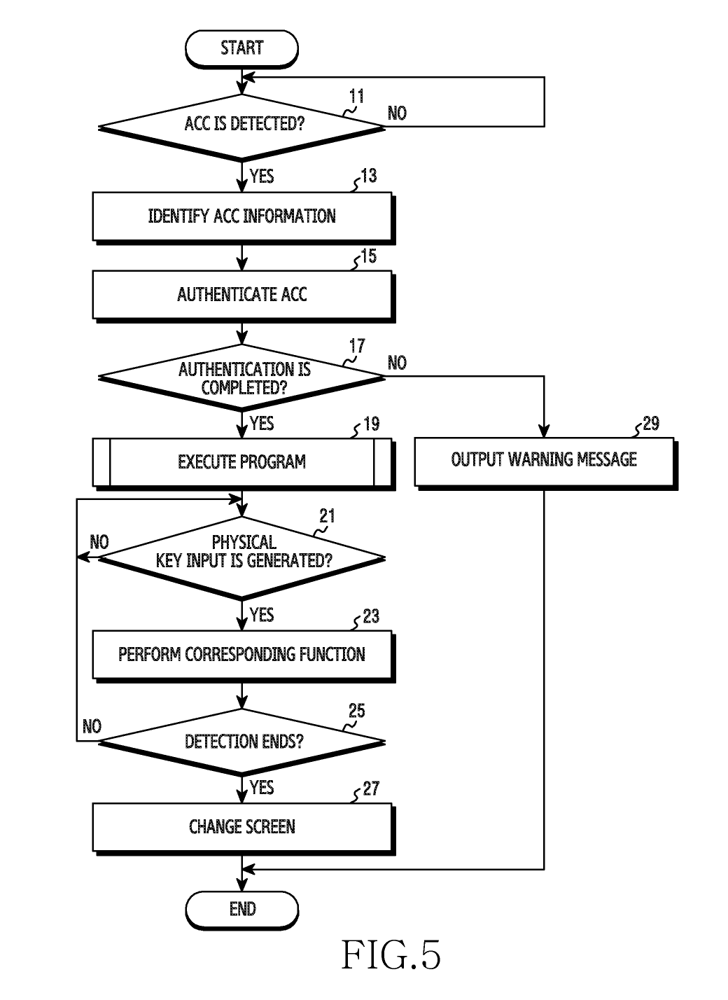

FIG. 5 is a flowchart illustrating a method of controlling the electronic device 400 by using an accessory device 700 according to an embodiment of the present disclosure.

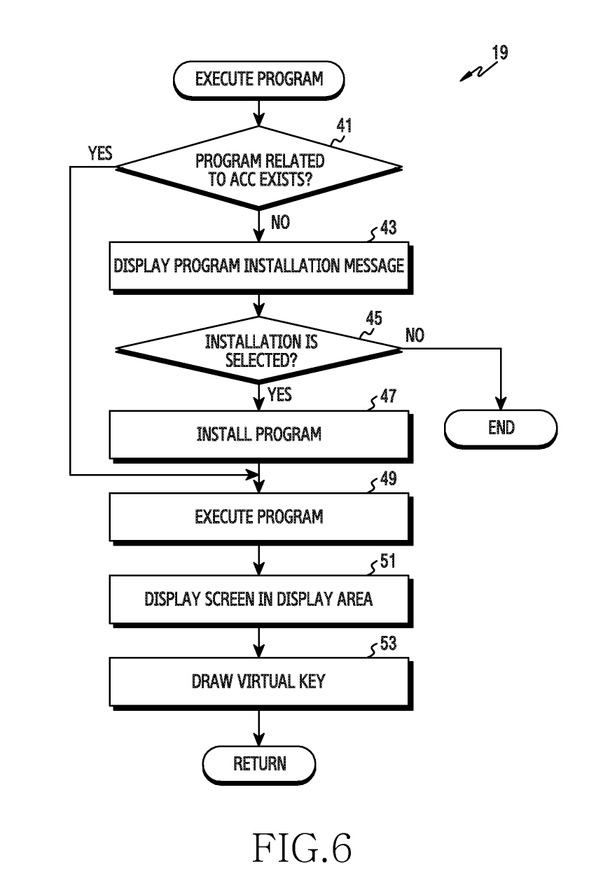

FIG. 6 is a flowchart illustrating a method of executing a program corresponding to the accessory device 700 according to an embodiment of the present disclosure.

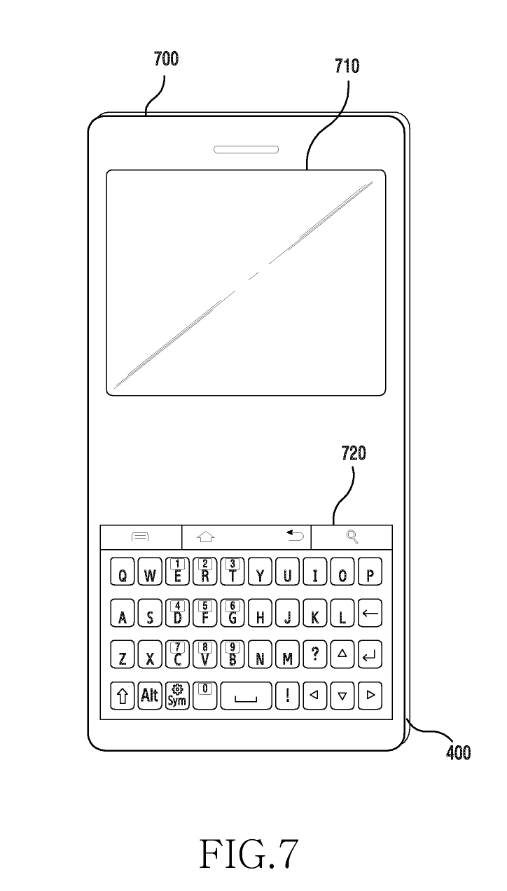

FIGS. 7 to 11 illustrate screen examples for describing an operation of the electronic device 400 to which the accessory device 700 is mounted according to various embodiments of the present disclosure.

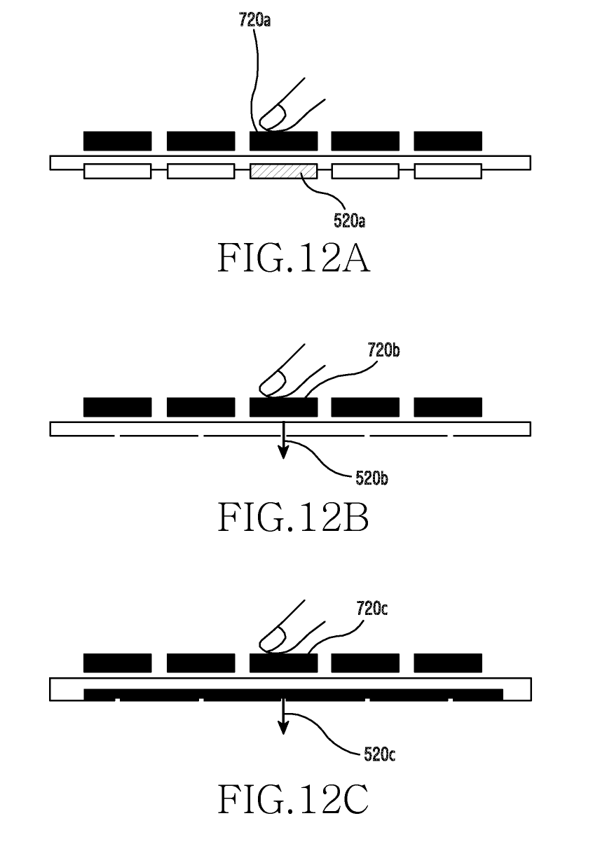

FIGS. 12A, 12B, and 12C illustrate a screen example for describing a structure of a physical key 720 formed in the accessory device 700 according to various embodiments of the present disclosure.

Referring to FIGS. 5 to 12C, the electronic device 400 may identify whether the accessory device (Acc) 700 mounted to the electronic device 400 is detected in operation 11. When the accessory device 700 is detected based on a result of the identification of operation 11, the electronic device 400 may perform operation 13. When the accessory device 700 is not detected, the electronic device 400 may continuously attempt to detect the accessory device 700.

An operation for detecting the accessory device 700 mounted to the electronic device 400 will be described in more detail with reference to FIG. 7. The accessory device 700 including a display window 710 and at least one physical key 720 may be mounted to the electronic device 400. At this time, the accessory device 700 may be a cover accessory device which covers an entire upper part of the electronic device 400 as illustrated in FIG. 7. Further, the accessory device 700 may include at least one physical key and may be formed to cover only a partial upper part of the electronic device 400.

The display window 710 of the accessory device 700 may be formed with a transparent material. At least one physical key 720 of the accessory device 700 may be a keypad with a qwerty keyboard as illustrated in FIG. 7. The electronic device 400 include, according to a manufacturer, a keypad with the qwerty keyboard, a 3×4 array keypad, a keypad including the qwerty keyboard and a function key, a keypad including a game control key for controlling a game, and a touch pad which can be touched using an external device.

The accessory device 700 may communicate with the electronic device 400 through short-range communication such as NFC, RFID, or the like. Further, the accessory device 700 may be connected to a port included in the rear surface of the electronic device 400 through a wire to perform communication. The electronic device 400 may detect a state where the accessory device 700 connected through wireless or wired communication covers the touch screen 419. The electronic device 400 may detect the state where the accessory device 700 covers the touch screen 719 by a hall sensor included in the accessory device 700. The electronic device 400 may detect the state where the accessory device 700 covers the touch screen 419 through a sensor such as an illumination sensor included in the touch screen 419.

The electronic device 400 may identify information received from the accessory device 700 through wireless communication or wired communication in operation 13. For example, information on the accessory device 700 may include at least one of a manufacturer of the accessory device 700, whether the accessory device 700 is a genuine product, a product name, a color, a type of the accessory device 700, an ID format, a type and arrangement information on at least one physical key 720 included in the accessory device 700, information on the display window 710 formed in the accessory device 700, and an access address of a webpage of a manufacturer.

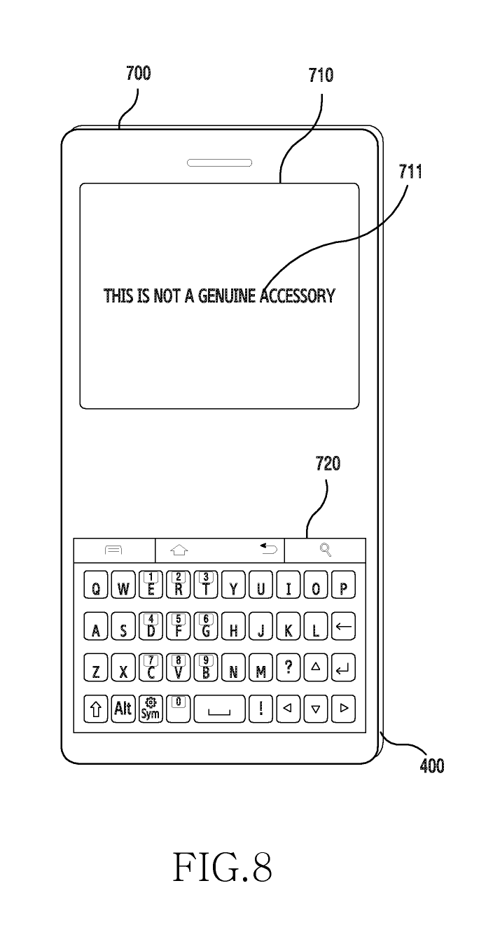

The electronic device 400 may authenticate the accessory device 700 in operation 15. For example, the electronic device 400 may authenticate the accessory device 700 by using information on whether the accessory device 700 is a genuine product which is included in the information on the accessory device 700. When the authentication of the electronic device 400 is completed in operation 17, the electronic device 400 may perform operation 19. When the authentication of the electronic device 400 is not completed, the electronic device 400 may perform operation 29. In operation 29, the electronic device may display a warning message 711 informing that the accessory device 700 is not a genuine product on the touch screen 419 as illustrated in FIG. 8. When displaying the warning message 711, the electronic device 400 may identify information on the display window among the information on the accessory device 700. The electronic device 400 may display the warning message 711 in a location of the touch screen 719 corresponding to the identified information on the display window.

The electronic device 400 may execute a program corresponding to the accessory device 700 of which authentication has been completed in operation 19. An operation for executing the program will be described in more detail with reference to FIG. 6. The electronic device 400 may identify whether there is a program related to the accessory device 700 in the memory 421 in operation 41. When there is a program related to the accessory device 700 based on a result of the identification in operation 41, the electronic device 400 may perform operation 49. When there is no program related to the accessory device 700 based on a result of the identification in operation 41, the electronic device 400 may perform operation 43.

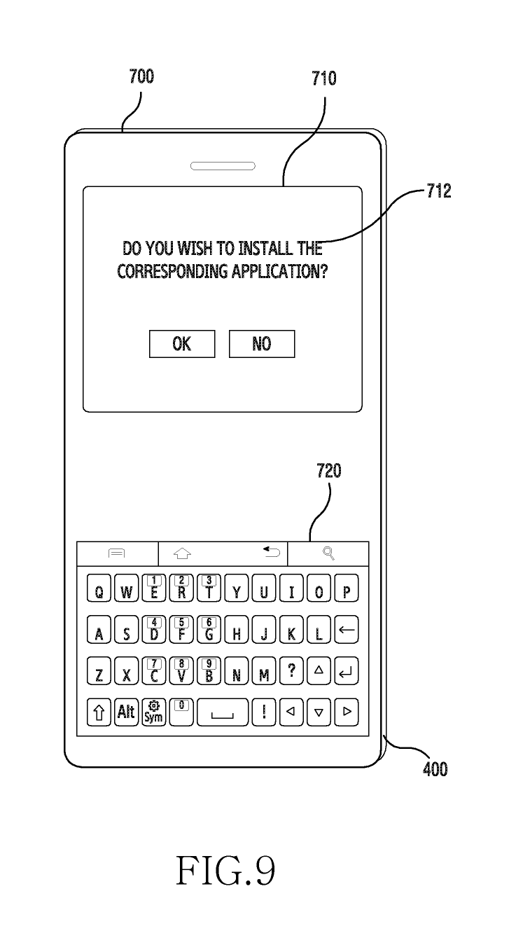

In operation 43, the electronic device 400 may display a notification message 712 for installing the program related to the accessory device 700 on the touch screen 419 as illustrated in FIG. 9. When displaying the notification message 712, the electronic device 400 may identify information on the display window among the information on the accessory device 700. The electronic device 400 may display the notification message 712 in a location of the touch screen 419 corresponding to the identified information on the display window.

When a selection signal of OK in the notification message 712 is received in operation 45, for example, when installation of the program is selected, the electronic device 400 may perform operation 47. When a selection signal of NO in the notification message 712 is received in operation 45, for example, when non-installation of the program is selected, the electronic device 400 may end the operation.

In operation 47, the electronic device 400 may access a server (not shown) existing outside the electronic device 400, download the program related to the accessory device 700, and install the downloaded program. At this time, the server may be at least one of a content providing server, a play store server, a market server, and a manufacturer webpage of the accessory device. The electronic device 400 may execute the installed program in operation 49.

In operation 49, the electronic device 400 may set a display area and an input area in the touch screen 419 based on the executed program. The electronic device 400 may set the display area based on the information on the display window 710 of the accessory device 700 by the program. The electronic device 400 may set the input area based on the information on at least one physical key 720 of the accessory device 700 by the program.

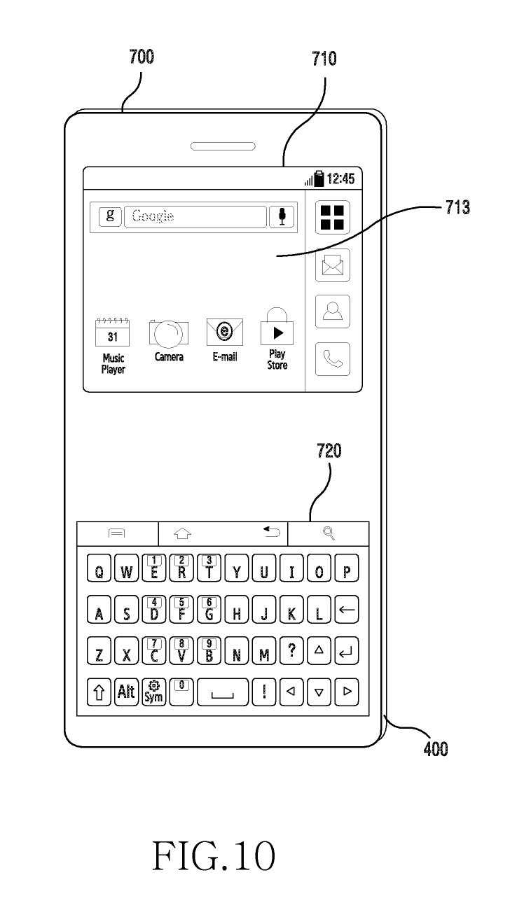

The electronic device 400 may display screen data in the set display area in operation 51. For example, the electronic device 400 may display screen data 713 corresponding to execution of the program in the display area corresponding to the display window 710 of the accessory device 700 as illustrated in FIG. 10. When the accessory device covers the touch screen 419 or is mounted to the touch screen 419 in a state where a standby screen is displayed on the touch screen 419, the electronic device 400 may resize the standby screen to fit the display area. The electronic device 400 may display the resized screen data in the display area. The electronic device 400 may rearrange one or more icons, which had been in the standby screen displayed on the touch screen 419 before the resizing, and display the rearranged icons in the display area.

When execution of a particular application is detected in a state where the accessory device 700 covers the touch screen 419, the electronic device 400 may display an execution screen of the particular application in the display area. The electronic device 400 may control the execution screen to fit the display area and display the execution screen in the display area.

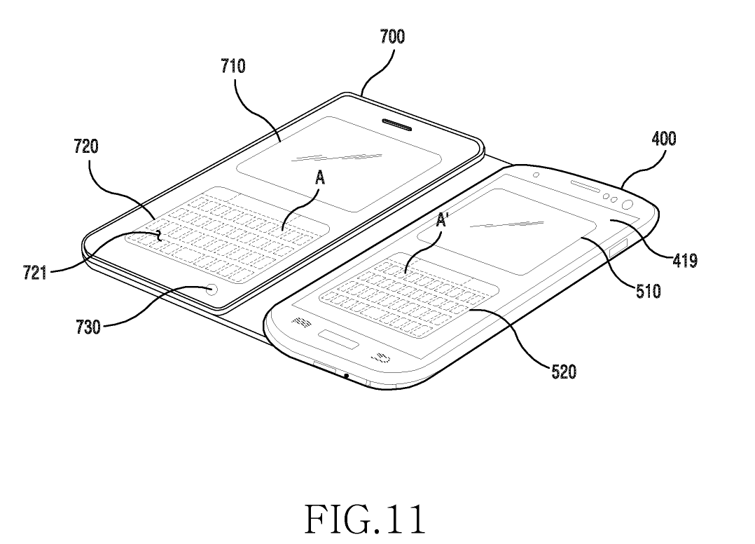

In operation 53, the electronic device 400 may identify the type and arrangement information on at least one physical key 720 from the information on the accessory device 700 through the program. The electronic device 400 may draw at least one virtual key corresponding to the identified type and arrangement information on at least one physical key 720 in the set input area. Displaying the screen data 713 and drawing the virtual key will be described in more detail with reference to FIG. 11.

The electronic device 400 may identify the information on the display window 710 from the information on the accessory device 700. The electronic device 400 may set an area corresponding to the identified display window 710 of the touch screen 419 as the display area 510. The electronic device 400 may display screen data corresponding to the execution of the program in the display area 510. The electronic device 400 may identify the type and arrangement information on at least one physical key 720 from the information on the accessory device 700. On the side opposite to the side where the physical key 720 is generated, for example, the side facing the touch screen 419 of the electronic device 400, the physical key 720 may be protected by a particular medium 721. The electronic device 400 may set an area corresponding to the identified physical key 720 of the touch screen 419 as the input area 520.

The electronic device 400 may draw at least one virtual key having the same type and arrangement information as that of at least one physical key 720 in the set input area 520. At this time, the electronic device 400 only draws the virtual key but does not actually display the virtual key on the touch screen 419. The electronic device 400 may allocate a key value, which is equal to that allocated to the physical key, to the drawn virtual key.

In operation 21, the electronic device 400 may identify whether an input for a particular physical key A is generated. When the input for the physical key A is generated based on a result of the identification in operation 21, the electronic device 400 may perform operation 23. When the input for the physical key A is not generated, the electronic device 400 may wait for the generation of the input. The electronic device 400 may perform a function corresponding to the generated input in operation 23. An operation for performing the function corresponding to the generated input for the physical key A will be described in more detail with reference to FIGS. 11 to 12C.

Referring to FIG. 11, when the accessory device 700 covers the upper part of the electronic device 400, the electronic device 400 may detect a hall sensor 730 included in the accessory device 700. When the electronic device 400 detects the hall sensor 730, the electronic device 400 may execute a program corresponding to the accessory device 700. The electronic device 400 may set the display area 510 and the input area 520 in the touch screen 419 based on the program. The electronic device 400 may draw a virtual key in the input area equally to the physical key 720. The electronic device 400 may allocate a key value, which is equal to that allocated to the physical key, to the drawn virtual key.

When an input is generated on the particular physical key A in a state where the accessory device 700 covers the upper part of the electronic device 400, the electronic device 400 may identify a virtual key A′ corresponding to the physical key A. The electronic device 400 may identify a coordinate value of a location of the virtual key A′. The electronic device 400 may identify a key value corresponding to the identified coordinate value and perform a function corresponding to the key value. The electronic device 400 may display screen data corresponding to the performed function in the display area 510 set to the touch screen 419.

Referring to FIGS. 12A to 12C, the physical key 720 may be formed by a protrusion type keyboard recognition pad as illustrated in FIG. 12A. In a state where the upper part of the electronic device 400 is covered by the accessory device 700 having the physical key 720 formed by the protrusion type keyboard recognition pad, an input may be generated on a particular physical key 720a. At this time, the physical key 720a on which the input is generated may move in a direction of the touch screen 419. By the physical key 720a having moved in the direction of the touch screen 419, a change in capacitance may be generated in a location corresponding to a virtual key 520a drawn on the touch screen 419. The electronic device 400 may detect the generated change in the capacitance and identify a coordinate value of the virtual key 520a having the generated change in the capacitance. The electronic device 400 may identify a key value corresponding to the identified coordinate value and perform a corresponding function.

The physical key 720 may be formed by an insertion type keyboard recognition pad as illustrated in FIG. 12B. In a state where the upper part of the electronic device 400 is covered by the accessory device 700 having the physical key 720 formed by the insertion type keyboard recognition pad, an input may be generated on a particular physical key 720b. At this time, the physical key 720b on which the input is generated may move in a direction of the touch screen 419. By the physical key 720b having moved in the direction of the touch screen 419, a change in capacitance may be generated on a virtual key 520b drawn on the touch screen 419. The electronic device 400 may detect the generated change in the capacitance and identify a coordinate value of the virtual key 520b having the generated change in the capacitance. The electronic device 400 may identify a key value corresponding to the identified coordinate value and perform a corresponding function.

The physical key 720 may be formed by an insertion type conductive cover plate pad as illustrated in FIG. 12C. In a state where the upper part of the electronic device 400 is covered by the accessory device 700 having the physical key 720 formed by the insertion type conductive cover plate pad, an input may be generated on a particular physical key 720c. At this time, the physical key 720c on which the input is generated may move in a direction of the touch screen 419. By the physical key 720c having moved in the direction of the touch screen 419, a change in capacitance may be generated on a virtual key 520c drawn on the touch screen 419. The electronic device 400 may detect the generated change in the capacitance and identify a coordinate value of the virtual key 520c having the generated change in the capacitance. The electronic device 400 may identify a key value corresponding to the identified coordinate value and perform a corresponding function.

When the accessory device 700 is not detected in operation 25, the electronic device 400 may perform operation 27. For example, when the accessory device 700 covering the upper part of the electronic device 400 is open and does not cover the upper part of the electronic device 400 as illustrated in FIG. 10, the electronic device 400 may perform operation 27. The electronic device 400 may change the screen data, which is being displayed in the display area, to correspond to the size of the touch screen 419 and display the screen data on the touch screen 419. The electronic device 400 may rearrange and display at least one icon arranged in the screen data which is displayed in the display area.

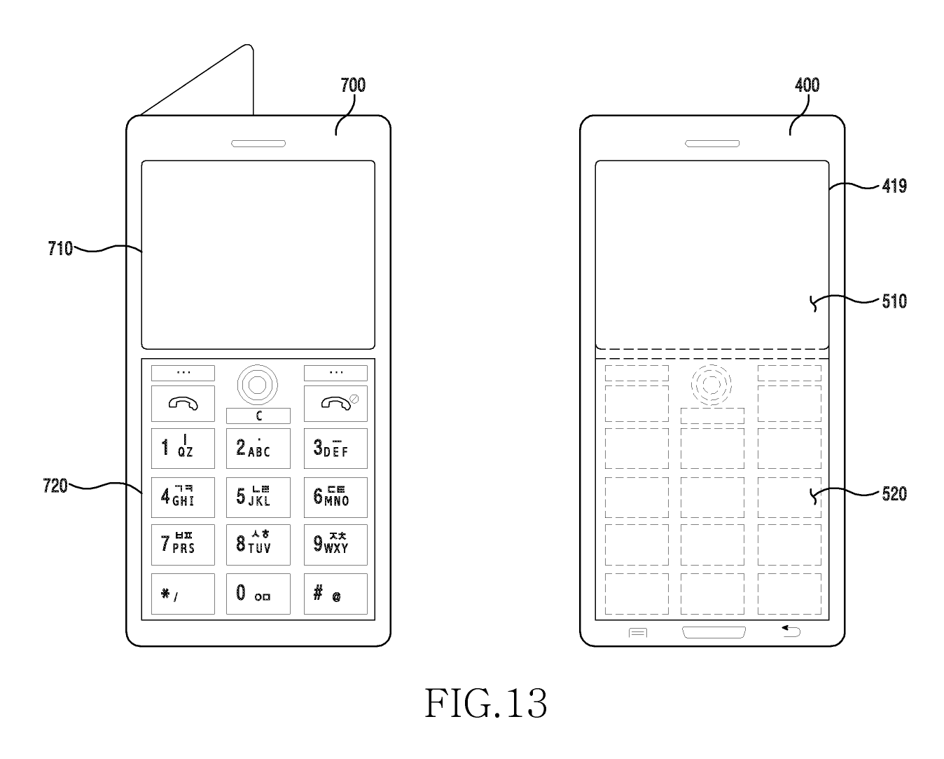

FIGS. 13 to 15 illustrate screen examples for describing a cover type accessory device according to various embodiments of the present disclosure.

Referring to FIGS. 13 to 15, the accessory device 700 including the display window 710 and at least one physical key 720 may be mounted to the electronic device 400. At this time, the accessory device 700 may be a cover accessory device which covers an entire upper part of the electronic device 400 as illustrated in FIGS. 13 to 15.

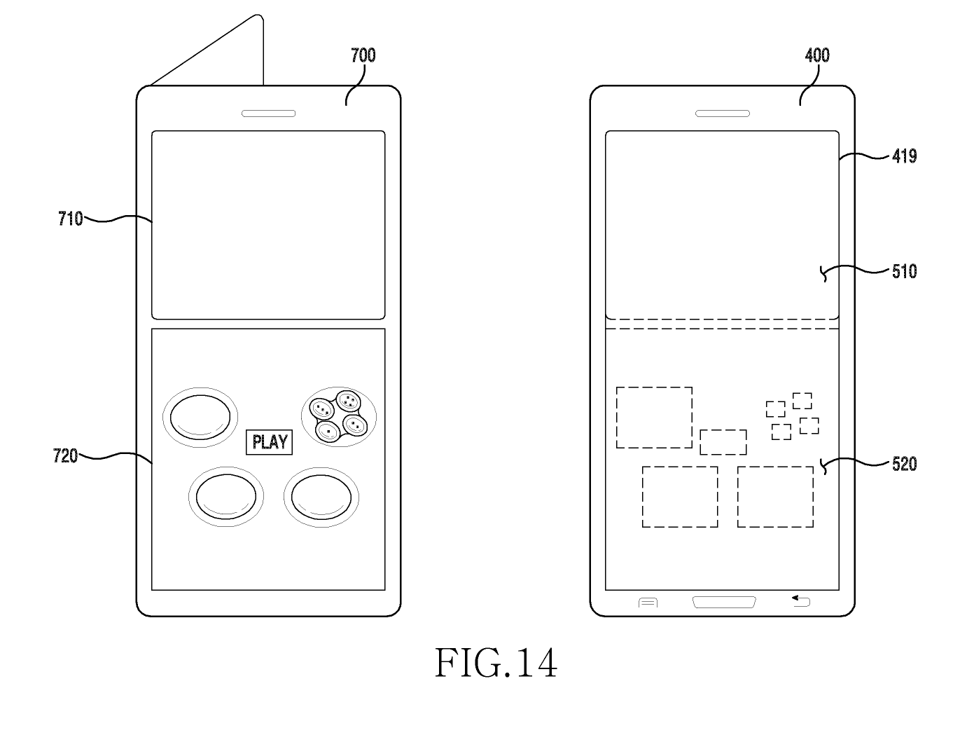

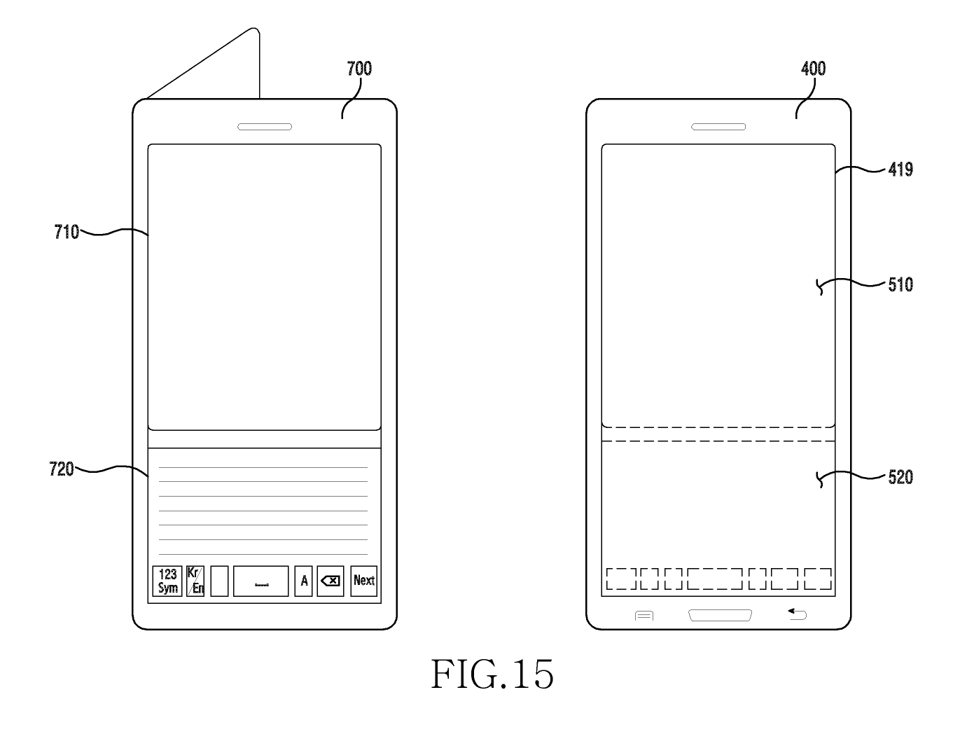

The display window 710 of the accessory device 700 may be formed with a transparent material. At least one physical key 720 of the accessory device 700 may be formed by a 3×4 array keypad as illustrated in FIG. 13. At least one physical key 720 of the accessory device 700 may be formed by a keypad including a game control key for controlling a game as illustrated in FIG. 14. At least one physical key 720 of the accessory device 700 may be formed with a transparent material to touch the input area 520 by using an external device, for example, a touch pen as illustrated in FIG. 15.

When it is detected that the accessory device 700 covers the upper part of the touch screen 419, the electronic device 400 may perform the operations illustrated in FIGS. 5 and 6. The electronic device 400 may divide the touch screen 419 equally to the display window 710 and the physical key 720 of the accessory device 700 to generate the display area 510 and the input area 520.

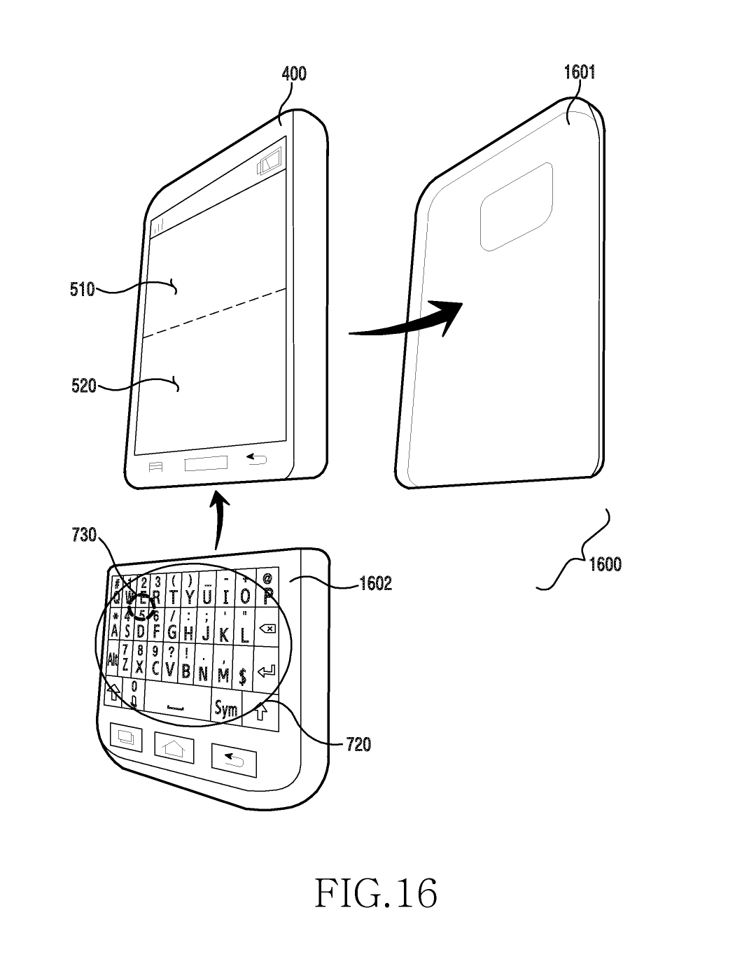

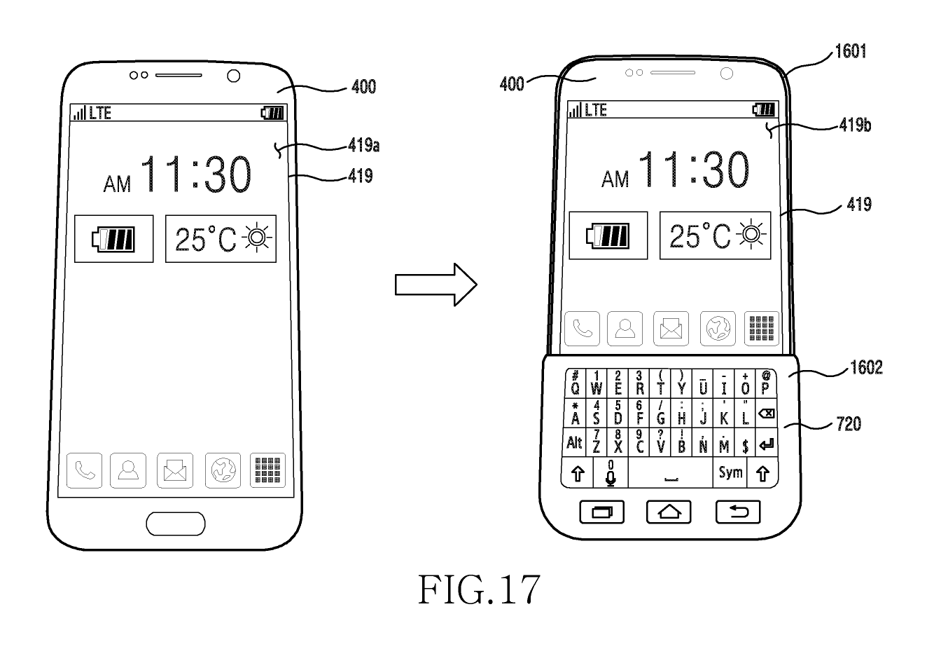

FIGS. 16 and 17 illustrate screen examples for describing a mounted type accessory device according to various embodiments of the present disclosure.

Referring to FIGS. 16 and 17, an accessory device 1600 may include a pair of a case 1601 mounted to the rear surface of the electronic device 400 and a case 1602 mounted to the front surface of the electronic device 400, for example, the touch screen 419 as illustrated in FIG. 16. In this case, the rear case 1601 of the accessory device 1600 may include a chip through which NFC communication with the electronic device 400 is possible. The front case 1602 of the accessory device 1600 may include at least one physical key 720 and the hall sensor 730.

The front case 1602 of the accessory device 1600 may be formed to slide onto the electronic device 400 in an upward direction from the bottom. When it is detected that the accessory device 1600 is mounted to the electronic device 400, the electronic device 400 may perform the operations illustrated in FIGS. 5 and 6.

Referring to FIG. 17, the electronic device 400 may display screen data, for example, a standby screen 419a on the touch screen 419. When it is detected that the accessory device 1600 is mounted to the electronic device 400 in a state where the standby screen 419a is displayed, the electronic device 400 may set a part of the touch screen 419 as the display area 510. The electronic device 400 may set parts other than the display area 510 as the input area 520. The electronic device 400 may generate an area, which is equal to the size of the front case 1602 of the accessory device 700, as the input area 520. The electronic device 400 may generate an area other than the input area 520 of the touch screen 419, for example, an area exposed by the front case 1602, as the display area 510.

The electronic device 400 may resize the standby screen 419a to be equal to the display area 510. The electronic device 400 may display the resized standby screen 419b in the display area 510. The electronic device 400 may rearrange at least one icon located in the standby screen 419a at a time point of the resizing. When the front case 1602 of the accessory device 700 is removed from the touch screen 419, the electronic device 400 may resize the standby screen 419b displayed in the display area 510 to be equal to the size of the touch screen 419. The electronic device 400 may display the resized standby screen 419b in on the touch screen 419.

According to an embodiment of the present disclosure, a method of controlling the electronic device 400 including the touch screen (for example, the display unit 419) may include an operation for detecting that the accessory device including at least one physical key is mounted to the electronic device 400, an operation for setting the input area corresponding to the physical key and the remaining display area in the touch screen 419, and an operation for displaying screen data in the set display area. The screen data may include at least one item. The operation for displaying the screen data in the display area may include an operation for arranging the at least one item in the display area.

The operation for displaying the screen data may include an operation for controlling the screen data according to an input detected in the input area, and displaying the controlled screen data.

An operation for detecting that the accessory device is removed from the electronic device may include an operation for displaying the screen data in an entire area of the touch screen 419.

The operation for setting the input area and the display area may include an operation for authenticating the accessory device, an operation for executing a program corresponding to the accessory device, and an operation for setting the display area and the input area based on the program.

The operation for executing the program may include an operation for executing the program if the program is installed in the electronic device 400. The operation for executing the program may include, an operation for accessing a server if the program is not installed in the electronic device 400, an operation for installing the program and an operation for executing the program.

The program may include information on a type and arrangement information on the at least one physical key, and the operation for setting the display area and the input area based on the program may include an operation for drawing at least one virtual key corresponding to information on the at least one physical key in the input area.

The operation for displaying the screen data may include an operation for identifying a virtual key in response to an input detected on at least one physical key, controlling screen data according to a key value corresponding to the virtual key, and displaying the controlled screen data.

The computer readable recoding medium may include a hard disk, a floppy disk, magnetic media (e.g., a magnetic tape), optical media (e.g., a compact disc ROM (CD-ROM) and a DVD), magneto-optical media (e.g., a floptical disk), a hardware device (e.g., a ROM, a RAM, a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of controlling an electronic device including a touch screen, the method comprising:
detecting that an accessory device including at least one physical key is mounted to the electronic device;
setting an input area corresponding to the physical key and a remaining display area in the touch screen; and
displaying screen data in the set display area.

2. The method of claim 1, wherein the displaying of the screen data comprises:
controlling the screen data according to an input detected in the input area; and
displaying the controlled screen data.

3. The method of claim 1, further comprising:
detecting that the accessory device is removed from the electronic device; and
displaying screen data in an entire area of the touch screen.

4. The method of claim 1, wherein the screen data includes at least one item.

5. The method of claim 4, wherein the displaying of the screen data in the display area comprises arranging the at least one item in the display area.

6. The method of claim 1, wherein the setting of the input area and the display area comprises:
authenticating the accessory device;
executing a program corresponding to the accessory device; and
setting the display area and the input area based on the program.

7. The method of claim 6, wherein the executing of the program comprises executing the program if the program is installed in the electronic device.

8. The method of claim 6, wherein the executing of the program comprises:
accessing a server if the program is not installed in the electronic device;
installing the program; and
executing the program.

9. The method of claim 6, wherein the program includes information on a type and arrangement information on the at least one physical key, and
wherein the setting of the display area and the input area based on the program comprises drawing at least one virtual key corresponding to information on the at least one physical key in the input area.

10. The method of claim 9, wherein the displaying of the screen data comprises:
identifying the virtual key in response to an input detected on the at least one physical key;
controlling the screen data according to a key value corresponding to the virtual key; and
displaying the controlled screen data.

11. An apparatus comprising:
a sensor unit configured to detect that an accessory device including at least one physical key is mounted to an electronic device including a touch screen; and
a controller configured to:
set an input area corresponding to the physical key and a remaining display area in the touch screen, and
control to display screen data in the set display area.

12. The apparatus of claim 11, wherein the controller is configured to control to display the screen data according to an input detected in the input area.

13. The apparatus of claim 11, wherein the controller is configured to control to display screen data in an entire area of the touch screen if the accessory device is removed from the electronic device.

14. The apparatus of claim 11, wherein the screen data includes at least one item.

15. The apparatus of claim 14, wherein the controller is configured to arrange the at least one item in the display area.

16. The apparatus of claim 11, wherein the controller is configured to:
authenticate the accessory device,
execute a program corresponding to the accessory device, and
set the display area and the input area based on the program.

17. The apparatus of claim 16, wherein the controller is configured to execute the program if the program is installed.

18. The apparatus of claim 16, wherein the controller is configured to: access
a server to install the program if the program is not installed, and
install the program.

19. The apparatus of claim 16, wherein the program includes information on a type and arrangement information on the at least one physical key, and the controller is configured to draw at least one virtual key corresponding to information on the at least one physical key in the input area.

20. The apparatus of claim 19, wherein the controller is configured to:
identify the virtual key in response to an input detected on the at least one physical key, and
control to display the screen data according to a key value corresponding to the virtual key.
